(19) United States
(12) Patent Application Publication
(10) Pub. No.: US 2026/0339653 A1
(43) Pub. Date: Oct. 29, 2026

(54) CLOUD-TO-CODE TRACING

(71) Applicant: Palo Alto Networks, Inc., Santa Clara, CA (US)

(72) Inventors: Pushpa Sekhara Reddy Matli, Parker, CO (US); Hariprasanna Srinivasan, San Jose, CA (US); Alexandre Silva Cezar, Orlando, FL (US); Srikumar Narayan Chari, Cupertino, CA (US)

(21) Appl. No.: 19/193,659

(22) Filed: Apr. 29, 2025

(51) Int. Cl. G06F 8/70; G06F 9/455; G06F 11/07; G06F 21/56

(52) U.S. Cl. CPC G06F 8/70; G06F 9/45558; G06F 11/0793; G06F 21/56; G06F 2009/45587; G06F 2009/45591

(57) ABSTRACT

A cloud-to-code tracer has been created to trace a security issue in a cloud-based workload to the source of the security issue. Based on detecting a security issue with a workload, the cloud-to-code tracer traces the workload to a file that is the source of the security issue. The cloud-to-code tracer retrieves a tracing sequence based on the workload type. The tracing sequence indicates a sequence of cloud-computing resource types that correspond to the deploy, build, and code stages of the workload. Based on the tracing sequence, the cloud-to-code tracer identifies instances of cloud-computing resources that correspond to the deploy, build, and code stages of the workload. Based on the trace, the cloud-to-code tracer identifies a code repository where the file(s) for the cloud-based workload is hosted. The cloud-to-code tracer can generate a visualization of the tracing to allow a custodian of the cloud-based workload to remediate the security issue.

### BACKGROUND

The disclosure generally relates to tracing a security issue in a workload to its source (CPC Class G06F subsection 8/00)

Cloud service providers (CSPs) offer different cloud delivery models (e.g., Infrastructure as a Service (IaaS), Platform as a Service (PaaS), and Software as a Service (SaaS)). IaaS provides resources including compute, storage, networking, and virtualization resources. PaaS provides, in addition to IaaS resources, resources for building, deploying, and managing applications, such as databases and development tools. Organizations which use PaaS offerings can use development tools to configure pipelines such as Continuous Integration/Continuous Delivery (CI/CD) pipelines to automate the building and deployment of cloud-computing resources which implement their applications. CI/CD pipelines generate artifacts (e.g., build logs) to maintain a clear record of the stages of operations taken to deploy a cloud-computing resource.

### BRIEF DESCRIPTION OF THE DRAWINGS

Embodiments of the disclosure may be better understood by referencing the accompanying drawings.

FIG. 1 is a diagram of a cloud-to-code tracer identifying a file that is the source of a security issue in a container type workload.

FIG. 2 is a diagram of a cloud-to-code trace graph representing a trace relevant to multiple possible security issues detected for a container workload to files in a code repository.

FIG. 3 is a diagram of a cloud-to-code trace graph representing a trace of two security issues detected for a virtual machine (VM) workload to files in a code repository.

FIG. 4 is a diagram of a cloud-to-code trace graph representing a trace of a security issue detected for a serverless function workload to a file in a code repository.

FIG. 5 is a flowchart of example operations for tracing a security issue detected in a cloud-based workload to the source of the security issue.

FIG. 6 is a flowchart of example operations for generating a cloud-to-code graph and generating a remediation action to address a security issue in a cloud-based workload.

FIG. 7 depicts an example computer system with a cloud-to-code tracer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description uses the term “cloud-based workload” to refer to a cloud-computing resource that has been deployed for use. Deployment often refers to deploying into a production environment. A cloud-based workload often corresponds to a cloud-native application but is not necessarily a cloud-native application. For instance, a cloud-based workload can correspond to a microservice which could be a part of a cloud-native application. Examples of a cloud-based workload include a container, a VM, and a serverless function. Underlying a VM and a container is a VM image and a container image, respectively. A container image is an immutable file that is executed to instantiate a container. The container image includes layers of images for running a container. The layers of images include a base image of a filesystem, libraries, binaries, dependencies, and configuration files. A VM image can be considered a template or snapshot of a configured system. The VM image will at least include an operating system, libraries, and configuration files. A VM image can also include file for an application to be run in the instantiated VM.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

A cloud-to-code tracer has been created to trace a security issue in a cloud-based workload to the source of the security issue. Based on detecting a security issue (e.g., vulnerability, misconfiguration, secret exposure) in a cloud-based workload, the cloud-to-code tracer traces the cloud-based workload to a file that is the source of the security issue (e.g., a package manager file, an Infrastructure-as-Code (IaC) file, a configuration file). The cloud-to-code tracer retrieves a tracing sequence based on the cloud-based workload type. The tracing sequence indicates a sequence of cloud-computing resource types that correspond to the deploy, build, and code stages of the workload. Based on the tracing sequence, the cloud-to-code tracer identifies instances of cloud-computing resources that correspond to the deploy, build, and code stages of the workload. Based on the trace, the cloud-to-code tracer identifies a code repository where the file(s) for the cloud-based workload is hosted. The cloud-to-code tracer then retrieves application security (“AppSec”) scan data for the code repository and examines the AppSec scan data to identify a file that corresponds to the security issue based on the cloud-based workload type and security issue type. The cloud-to-code tracer can generate a visualization of the tracing (e.g., a graph) to allow a custodian of the cloud-based workload to remediate the security issue, which can involve the cloud-based workload being rebuilt and redeployed.

### Example Illustrations

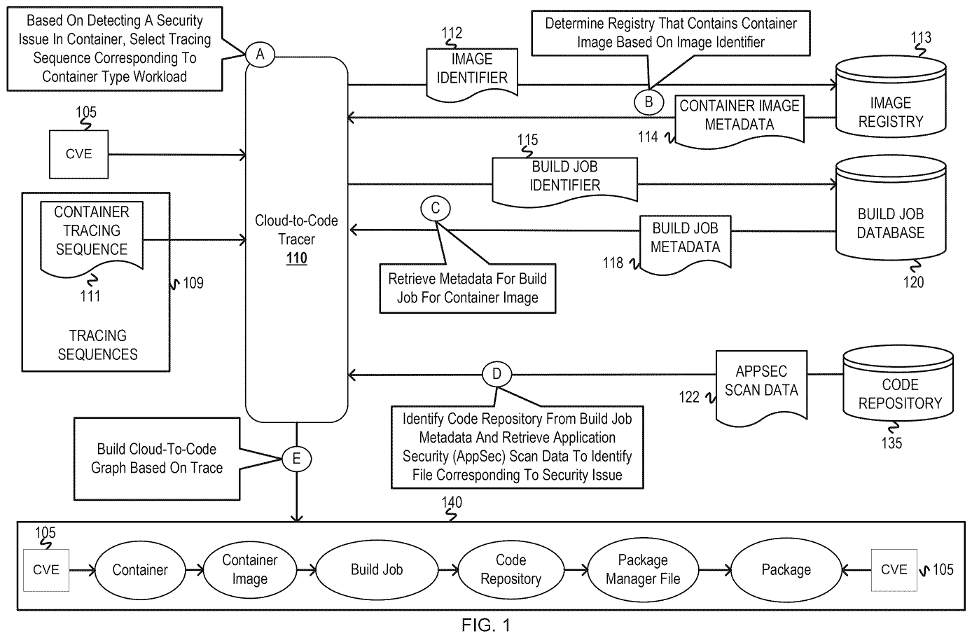

FIG. 1 is a diagram of a cloud-to-code tracer identifying a file that is the source of a security issue in a container type workload. FIG. 1 depicts a cloud-to-code tracer 110, an image registry 113, a database 120 of build jobs metadata, a code repository 135 and a cloud-to-code trace graph 140. The operations described below presume that a scanning agent/service has scanned the container workload and detected a security issue 105. The scanning agent/service determined a software bill of materials (SBOM) for an application image running inside the container.

FIG. 1 is annotated with a series of letters A-E representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the cloud-to-code tracer 110 selects a container tracing sequence 111 based on receiving a notification of the security issue 105 in the container type workload (“container workload”). The security issue 105 indicates a common vulnerability or exposure (CVE) that identifies a package in the container workload. The cloud-to-code tracer 110 selects from a predefined set of tracing sequences 109 the container tracing sequence 111 based on the workload being a container. The container tracing sequence 111 indicates a sequence of cloud-computing resource types that correspond to the deploy, build, and code stages of the container workload. An example of a container tracing sequence is: Container→Container Image→Build Job→Code Repository.

At stage B, the cloud-to-code tracer 110 determines a registry, in this case the image registry 113, that contains the container image based on an image identifier 112 (e.g., image digest) of the container workload. A notification of the security issue 105 will have identified the image identifier for the container workload. The cloud-to-code tracer 110 uses the image identifier 112 to identify the image registry 113 and retrieve metadata 114 of the container image from the image registry 113.

At stage C, the cloud-to-code tracer 110 retrieves build job metadata 118 for a build job that built the container image corresponding to the container image identifier 112. The cloud-to-code tracer 110 determines, using the container image metadata 114, a name/identifier 115 of a build job that published the container image to the image registry 113. The cloud-to-code tracer 110 queries the database 120 of build job logs with the build job identifier 115 and retrieves the build job metadata 118. The build job metadata 118 includes a code repository identifier (e.g., a repository name) and a file identifier that corresponds to a workload generation instruction file (e.g., a Docker® file) in that code repository.

At stage D, the cloud-to-code tracer 110 identifies the code repository 135 from the build job metadata 118 and retrieves AppSec scan data 122 and identifies the file in the code repository 135 that corresponds to the security issue. A code scanner will have scanned the code repository 135 and identified dependencies and vulnerabilities indicated in the AppSec scan data 122 which is associated with the code repository 135. The cloud-to-code tracer 110 examines the AppSec scan data 122 to identify the file(s)/package described in the security issue 105.

Although the example in FIG. 1 depicts a single security issue 105 corresponding to a single file in a code repository, in practice multiple security issues can be detected in a cloud-based workload. In the case that multiple security issues are detected for a cloud-based workload, the cloud-to-code tracer 110 traces for each security issue and identifies the file corresponding to each security issue. Multiple security issues (e.g., multiple package vulnerabilities) may originate from the same file.

At stage E, the cloud-to-code tracer 110 builds the cloud-to-code trace graph 140 based on the performed trace. The cloud-to-code tracer 110 adds a graph node representing the container workload (i.e., the start of the trace) and then adds graph nodes representing the deploy, build and code stage resources that were identified based on the trace. The resource identifier corresponding to each identified resource can be stored as metadata in the corresponding graph node. In this example, the cloud-to-code tracer 110 adds graph nodes representing the container image, the build job, and the code repository. The cloud-to-code tracer 110 can also add graph nodes for additional resources (e.g., the image registry 113) which were identified based on the trace and provide additional context to the trace. The cloud-to-code tracer 110 also adds a graph node representing the package manager file that corresponds to the security issue 105 and a graph node representing the package in the package manager file that corresponds to the security issue 105. The generated cloud-to-code trace graph 140 also includes two nodes representing the security issue 105. The first instance of the security issue node 105 is represented having an outgoing directed edge pointing to the container workload and the second instance having an outgoing directed edge pointing to the package. The cloud-to-code trace graph 140 includes directed edges between the nodes that represent the relationships between the resources. The cloud-to-code tracer 110 can provide the cloud-to-code trace graph 140 to a downstream process (not depicted) to determine a remediation action to address the security issue 105.

FIG. 1 describes a case in which a trace from workload to a file was fully accomplished. In some cases, an incomplete trace can occur when the metadata of the deploy, build, and/or code stage resources is inaccessible or unavailable. In these cases, the cloud-to-code tracer 110 will generate a cloud-to-code trace graph based on the extent the trace was able to be performed. This may be accompanied by a notification to the custodian of the cloud-based workload that a remediation action to address the security issue was unable to be determined along with a reasoning (e.g., lack of permissions).

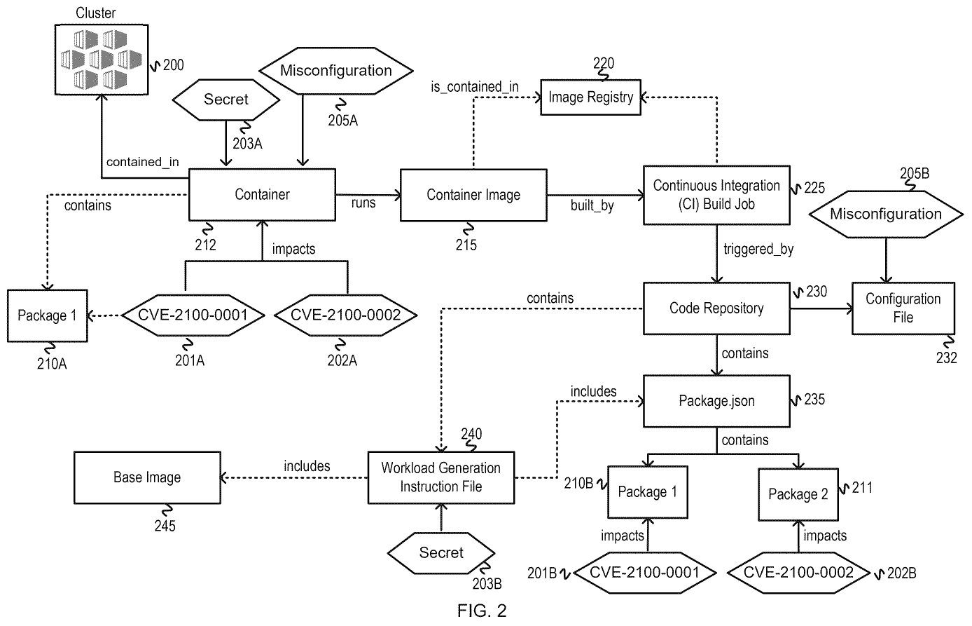

FIG. 2 is a diagram of a cloud-to-code trace graph representing a trace relevant to multiple possible security issues detected for a container workload to files in a code repository. The cloud-to-code trace graph depicted in FIG. 2 includes nodes representing a containerized application cluster 200, a container 212, a container image 215, a container image registry 220, a continuous integration (CI) build job 225, a code repository 230, a package manager file 235 labeled “Package.json”, a package 211 labeled “Package 2”, a workload generation instruction file 240, and a base image 245. FIG. 2 depicts multiple nodes 210A, 210B representing a package labeled “Package 1” to illustrate Package 1 being contained in the Package.json file and deployed in the container 212. The cloud-to-code graph also includes nodes representing several security issues, including CVE nodes 201A, 201B labeled “CVE-2100-0001”, CVE nodes 202A, 202B labeled “CVE-2100-0002”, secret nodes 203A, 203B and misconfiguration nodes 205A, 205B. The cloud-to-code trace graph includes directed edges with labels specifying the relationships between the nodes. The directed edge from the container 212 to the cluster 200 indicates “contained_in.” Similarly, the directed edge from the container 212 to the container image 215 indicates “runs”. The directed edge from the container 212 to the package 210 indicates “contains”. The directed edges from the CVE node 201A and the CVE node 202A to the container 212 both indicate “impacts”. The directed edge from the container image 215 to the image registry 220 indicates “is_contained_in”. Similarly, the directed edge from the container image 215 to the CI build job 225 indicates “built_by”. The directed edge from the CI build job 225 to the code repository 230 indicates “triggered_by”. The directed edge from the code repository 230 to the package manager file 235 indicates “contains”. Similarly, the directed edge from the code repository 230 to the workload generation instruction file 240 indicates “contains”. The directed edge from the workload generation instruction file 240 to the base image 245 indicates “includes”. Similarly, the directed edge from the workload generation instruction file 240 to the package manager file 235 indicates “includes”. The directed edge from the package manager file 235 to the package 210B indicates “contains”. Similarly, the directed edge from the package manager file 235 to the package 211 indicates “contains”. The directed edge from the CVE node 201A to the package 210 indicates “impacts”. The directed edge from the CVE node 202A to the package 211 also indicates “impacts”.

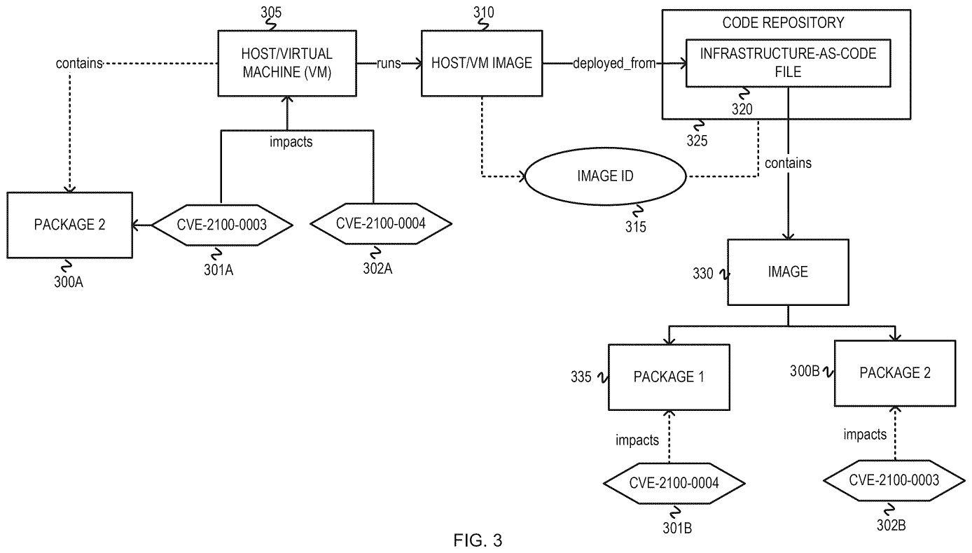

FIG. 3 is a diagram of a cloud-to-code trace graph representing a trace of two security issues detected for a VM workload to files in a code repository. The cloud-to-code trace graph depicted in FIG. 3 includes nodes representing a Host/VM 305, a Host/VM image 310, a code repository 325 with an internal node that represents an IaC file 320 in the code repository 325, and an image 330. FIG. 3 also includes package nodes 300A, 300B labeled “Package 2”, and a package node 335 labeled “Package 1”. The cloud-to-code trace graph also includes nodes representing two security issues, including CVE nodes 301A, 301B labeled “CVE-2100-0003,” and CVE nodes 302A, 302B labeled “CVE-2100-0004”. The cloud-to-code trace graph includes directed edges with labels specifying the relationships between the nodes. The directed edge from the host/VM 305 to the host/VM image 310 indicates “runs”. The directed edge from the host/VM 305 to the package node 300A indicates “contains”. The directed edges from the CVE nodes 301A, 302A to the host/VM 305 both indicate “impacts”. The directed edge from the host/VM image 310 to the IaC file 320 indicates “deployed_from”. The directed edge from the IaC file 320 to the image 330 indicates “contains”. The directed edge from the CVE node 301B to the package node 335 indicates “impacts”. The directed edge from the CVE node 302B to the package node 300B also indicates “impacts”.

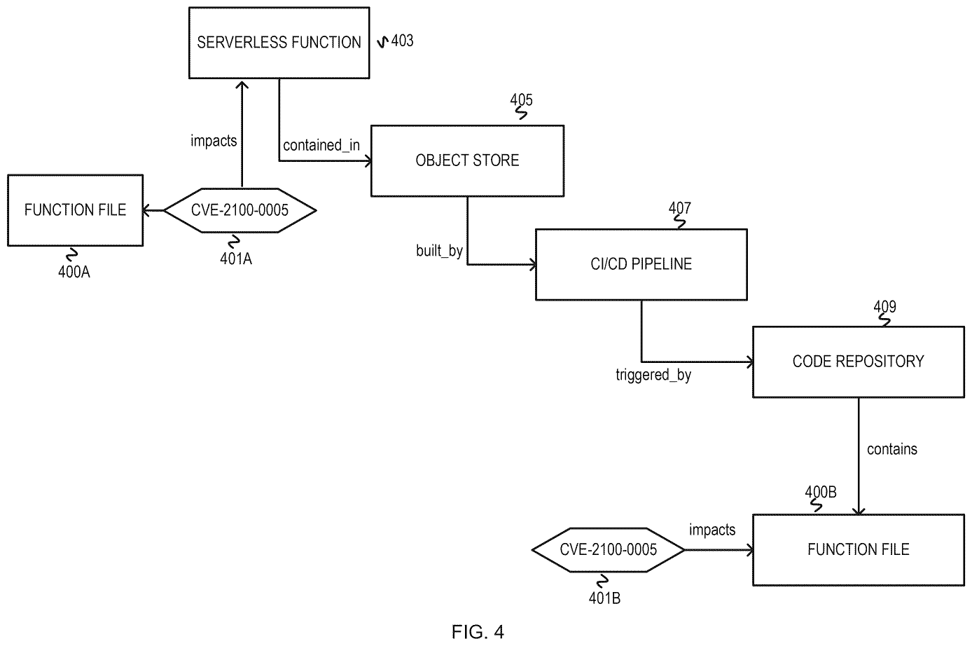

FIG. 4 is a diagram of a cloud-to-code trace graph representing a trace of a security issue detected for a serverless function workload to a file in a code repository. The cloud-to-code trace graph depicted in FIG. 4 includes nodes representing a serverless function 403, an object store 405, a CI/CD pipeline 407, and a code repository 409. The cloud-to-code trace graph depicted in FIG. 4 also includes function file nodes 400A, 400B. The cloud-to-code trace graph also includes CVE nodes 401A, 401B labeled “CVE-2100-0005”. The cloud-to-code trace graph includes directed edges with labels specifying the relationships between the nodes. The directed edge from the CVE node 401A to the serverless function 403 indicates “impacts”. The directed edge from the serverless function 403 to the object store 405 indicates “contained_in”. The directed edge between the object store 405 to the CI/CD pipeline 407 indicates “built_by”. The directed edge from the CI/CD pipeline 407 to the code repository 409 indicates “triggered_by”. The directed edge from the code repository 409 to the function file node 400B indicates “contains”. The directed edge from the CVE node 401B to the function file node 400B indicates “impacts”.

The cloud-to-code trace graphs depicted in FIGS. 2-4 are examples of trace graphs. Some trace graphs may illustrate varied tracing sequences even amongst workloads of the same type. For example, a tracing sequence for a serverless function may not depict a build stage resource. This can occur when a serverless function is manually packaged or packaged using a developer tool and uploaded to an object store without the use of a build job. VMs can also lack build stages in cases where a VM was instantiated using a pre-built VM image (e.g., an Amazon® Machine Image). If a deploy stage resource does not indicate a build stage resource, the cloud-to-code tracer will evaluate the deploy stage resource metadata for indications of a code stage resource. For example, if the deploy stage resource of a serverless function (e.g., an object store) does not indicate a build job, the cloud-to-code tracer looks for indications of a code stage resource (e.g., code repository) from the metadata of the deploy stage resource.

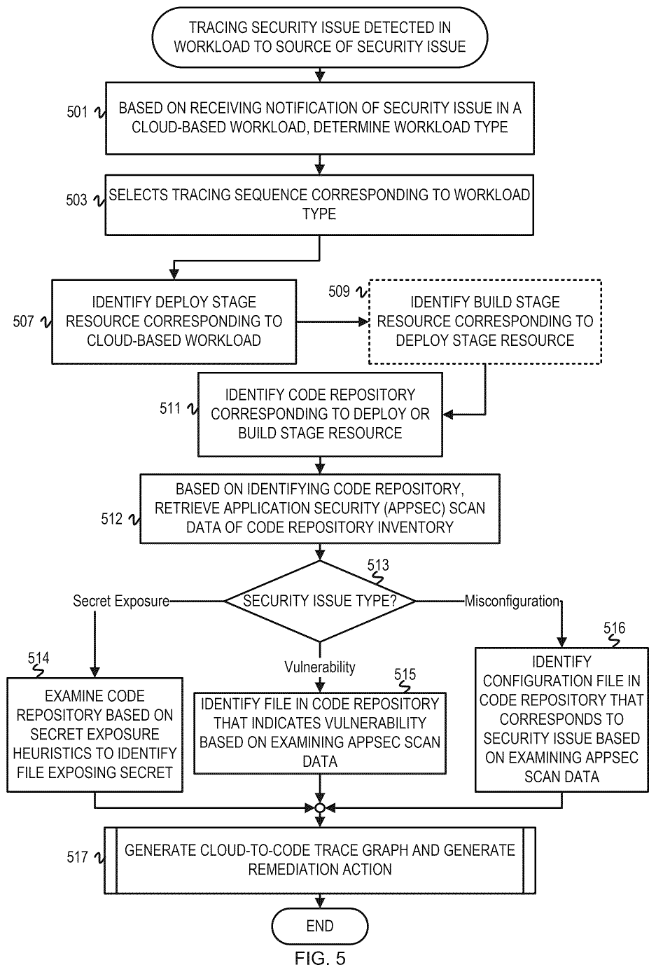

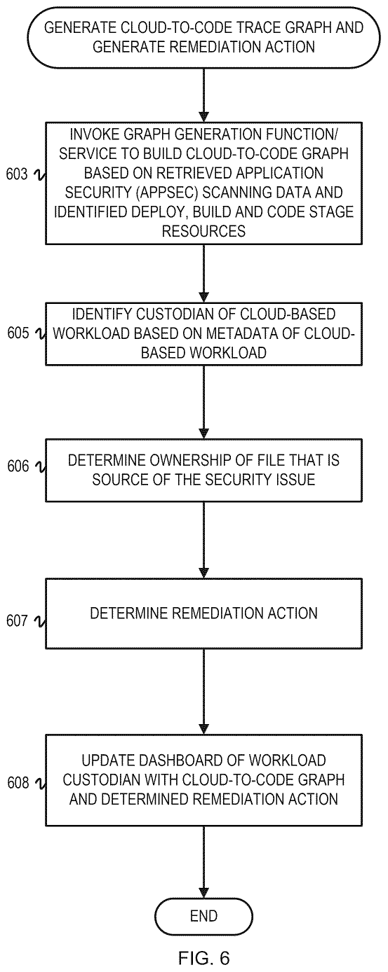

FIGS. 5-6 are flowcharts of example operations for tracing a security issue detected in a cloud-based workload to the source of the security issue. The example operations are described with reference to a cloud-to-code tracer for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 5 is a flowchart of example operations for tracing a security issue detected for a cloud-based workload to a file that corresponds to the security issue. FIG. 5 presumes a scanning agent/service has detected a security issue for a cloud-based workload and has notified the cloud-to-code tracer of the security issue. A runtime scanner (e.g., software composition analysis (SCA) scanner) periodically scans runtime workloads to determine a manifest or contents of the workloads (e.g., SBOMs). Multiple security scanners use the manifest to identify various security issues. When one of the security scanners detects a security issue, a notification is generated for the cloud-to-code tracer. As the workload is likely deployed into a production environment, the workload and any applications running therein can be referred to as production stage resources.

At block 501, the cloud-to-code tracer determines the type of workload impacted by a security issued based on receiving a notification of the security issue. The cloud-to-code tracer can determine a workload's type based on the notification of the security issue. The workload type can be determined from a workload identifier. For instance, a serverless function can have a function name and a container will be identified by a container image identifier indicated in the notification.

At block 503, the cloud-to-code tracer selects, from pre-defined tracing sequences, a tracing sequence that corresponds to the workload type. The pre-defined tracing sequences can be statically defined in the configuration of the cloud-to-code tracer. Each tracing sequence corresponds to a different workload type. A tracing sequence can indicate one or more resource types which correspond to the deploy, build and code stages of a workload based on the type of the cloud-based workload. These tracing stages are used to determine the deploy and build stage resources that can be used to trace a cloud-based workload and its code stage resource (i.e., a code repository). Below are examples of tracing sequences for a container, a virtual machine (VM), and a serverless function.
Tracing Sequences
---------------------------
Workload Type: Container
(Container→Container Image→Build Job→Code Repository)
---------------------------
Workload Type: Virtual Machine
(Virtual Machine→Virtual Machine Image→Code Repository)
---------------------------
Workload Type: Serverless Function
(Serverless Function→Object Store→CI/CD Pipeline→Code Repository)

At block 507, the cloud-to-code tracer identifies a deploy stage resource corresponding to the cloud-based workload. A deploy stage resource is an intermediary resource which relates the cloud-based workload to a build stage resource or a code repository. For containers, the deploy stage resource is a container image. For VMs, the deploy stage resource is a VM image. In both cases, the cloud-to-code tracer identifies an artifact or image registry where an image was published or stored. The cloud-to-code tracer queries the image registry using an image identifier that was determined by the scanning agent/service to search the image registry for the image and corresponding metadata. VM images and container images can be stored in different registries. For serverless functions, the cloud-to-code tracer uses a function identifier that corresponds to the serverless function that was determined by the scanning agent/service. The function identifier can be a hash value of the serverless function or a function name. The cloud-to-code tracer then queries a database of resource metadata using the function identifier to determine an object store where a file or package for the function is located. The cloud-to-code tracer stores an indicator of the deploy stage resource for later use in building the cloud-to-code trace graph.

At block 509, the cloud-to-code tracer identifies a build stage resource corresponding to the deploy stage resource. The cloud-to-code tracer examines metadata of the workload or the deploy stage resource to identify a build job or a CI/CD pipeline that built, published, or deployed an underlying resource (e.g., image) of the workload. This block of operation is dashed to illustrate it is an optional operation based on whether the tracing sequence for the cloud-based workload type indicates a build stage resource. If the retrieved tracing sequence does not indicate a build stage resource to identify, then operational flow continues at block 511. If the tracing sequence does indicate a build stage resource to identify, the cloud-to-code tracer attempts to identify the instance of the build stage resource that corresponds to the resource type indicated by the tracing sequence. The cloud-to-code tracer queries a data source of build job metadata using the deploy stage resource metadata. (i.e., the container image identifier, VM image identifier, or function identifier) to retrieve the metadata for a build job or a CI/CD pipeline that built the deploy stage resource. The results from the data source of build job metadata include at least the metadata of a build job that indicates the deploy stage resource identifier. The cloud-to-code tracer stores an indicator of the build job or CI/CD pipeline for later use in building the cloud-to-code trace graph.

At block 511, the cloud-to-code tracer identifies a code repository corresponding to the deploy or build stage resources. Based on whether the cloud-to-code tracer identified a build stage resource in block 509, the cloud-to-code tracer identifies a code repository based on the deploy stage resource metadata or the build stage resource metadata to identify a code repository that maintains the files for the cloud-based workload. If the cloud-to-code tracer identified a build job or CI/CD pipeline, the cloud-to-code tracer examines the metadata for the build job or CI/CD pipeline for indications of a code repository. Other systems or scanners will have scanned logs of build jobs of the cloud environment to extract metadata of the build job or index the logs to access metadata by build job identifier. Alternatively, the cloud-to-code tracer can run a process or call a function that searches logs for entries corresponding to a build identifier. The build job metadata includes an identifier of a code repository (e.g., a repository name) among other information about the build. For container and VM workloads, the metadata of a build job also includes an indication of a workload instruction generation file.

At block 512, the cloud-to-code tracer, based on identifying a code repository, retrieves AppSec scan data for the code repository. The cloud-to-code tracer uses the identifier of the code repository determined in block 511 as a lookup key or index to retrieve the AppSec scan data for the code repository. The AppSec scan data includes detected vulnerabilities, dependencies, etc.

At block 513, the cloud-to-code tracer determines the type of the security issue. Determination of the type of security issue drives analysis of the code repository resource(s). For instance, a different program code can be run depending upon security issue type. The cloud-to-code tracer examines the metadata of the security issue to determine the type of security issue. If the metadata of the security issue does not explicitly indicate a type, the cloud-to-code tracer can evaluate the description of the security issue to determine the type of the security issue. For example, a security issue description that includes an indication of a vulnerable package corresponds to a vulnerability. Likewise, a security issue description that describes a misconfiguration is an indicator of a misconfiguration. If not explicitly determinable from the metadata of the security issue, the cloud-to-code tracer can use a natural language processing (NLP) tool to evaluate text in the security issue description to make this determination. If the security issue is a secret exposure, then operational flow continues at block 514. If the security issue is a vulnerability, then operational flow continues at block 515. If the security issue is a misconfiguration, then operational flow continues at block 516.

At block 514, the cloud-to-code tracer examines the code repository based on secret exposure heuristics identify a file exposing the secret. Heuristics-based rules can specify the types of secrets that are likely exposed (e.g., key materials, credentials, etc.) and the cloud-to-code tracer can brute force search the files of the code repository. The heuristics-based rules can provide additional intelligence and specify file types and functions or commands observed as being associated with secret exposures. The cloud-to-code tracer can examine files of the specified file types for the specified functions or commands to identify which file(s) exposes a secret. The cloud-to-code tracer stores an indicator of the file(s) for later use in graph building based on identifying one or more of the files in the code repository that are exposing the secret.

At block 515, the cloud-to-code tracer identifies a file in the code repository that indicates a vulnerability based on examining the AppSec scan data. The security issue metadata or description indicates a file/package name. Based on examining the AppSec scan data, the cloud-to-code tracer identifies the matching file/package in the code repository. In cases where the security issue indicates a package name, the cloud-to-code tracer retrieves the contents for the workload generation instruction file that was indicated by the build stage resource metadata. The workload generation instruction file includes an indication of a package manager file. The cloud-to-code tracer examines the AppSec scan data to identify the indicated package manager file and retrieves the contents of the package manager file. The cloud-to-code tracer then examines the contents of the package manger file to verify the vulnerable package. The cloud-to-code tracer stores an indicator of the file that corresponds to the vulnerability for later use in graph building.

In some cases, a code scanner may have scanned the code repository at a previous point in time and identified from the AppSec scan data vulnerabilities in the code. Each of these detected vulnerabilities can have an assigned identifier based on the type of the vulnerability. For example, a package vulnerability may correspond to a CVE which was already assigned a unique identifier. In this case, the cloud-to-code scanner can correlate the security issue impacting the cloud-based workload with a file in the code repository and affirm the trace.

At block 516, the cloud-to-code tracer identifies a workload configuration file in the code repository that corresponds to the misconfiguration security issue based on examining the AppSec scan data. The description of the misconfiguration security issue references a file identifier (e.g., a file name) that corresponds to a file in the code repository that is indicated by the AppSec scan data. The cloud-to-code tracer identifies the configuration file in the code repository based on comparing the file identifier in the misconfiguration security issue to the AppSec scan data and identifying a configuration file with the same file identifier. The cloud-to-code tracer records an identifier of the configuration file for later use in graph building.

At block 517, the cloud-to-code tracer generates a cloud-to-code trace graph and generates a remediation action to address the security issue in the cloud-based workload. This operation is described in FIG. 6.

FIG. 6 is a flowchart of example operations for generating a cloud-to-code graph and generating a remediation action to address a security issue in a cloud-based workload. The example operations of FIG. 6 occur after the cloud-to-code tracer has traced a security issue in a cloud-based workload to a file in a code repository. However, implementations can incrementally build the cloud-to-code trace graph during the tracing.

At block 603, the cloud-to-code tracer invokes a graph generation function/service to build a cloud-to-code trace graph based on the retrieved AppSec scan data and identified deploy, build and code stage resources. The cloud-to-code tracer calls a graph building function or makes an API call to an external service to build the cloud-to-code trace graph. The cloud-to-code tracer includes as parameters to the graph-building function or as a payload in the API call the indicators for the deploy, build, and code stage resources identified based on the trace and their relationship information. The cloud-to-code tracer also includes the retrieved AppSec scan data and indicators of the workload and file that was determined to correspond to the security issue. The result obtained from the graph generation function/service includes at least a graph representation of the trace.

At block 605, the cloud-to-code tracer identifies a custodian of the cloud-based workload based on the metadata of the cloud-based workload. Some types of workloads (e.g., containers) can be part of a cluster of containers which correspond to an organization. A cluster orchestrator (e.g., the Kubernetes® cluster orchestrator) can logically divide clusters using namespaces for different business purposes (e.g., access control, resource limitation, application separation). The custodian of a cloud-based workload can be identified based on the namespace of the workload cluster with includes the cloud-based workload. The custodian of a VM workload or a serverless function workload can be determined based on examination of resource metadata captured by a cloud security posture management system which provides detailed visibility of the security state of an organization's resources and workload.

At block 606, the cloud-to-code tracer determines the ownership of the file that is the source of the security issue. The cloud-to-code tracer evaluates the metadata of the file to determine the entity that owns the file (e.g., an organization). Ownership in this context can correspond to an entity that owns the code in the file or can correspond to an entity which maintains the code repository which stores the file. The cloud-to-code tracer can determine ownership on an organizational level or on an individual level (e.g., an individual within an organization). In some cases, the cloud-to-code tracer can determine ownership of a file based on the name of the code repository that stores the file. For example, the name of a code repository can be “github.com/exampleorg/repo-name”, where “exampleorg” is the name of the organization that maintains the code repository.

At block 607, the cloud-to-code tracer determines a remediation action. Some types of security issues may have a predetermined remediation action for resolving the security issue. For example, a package vulnerability can be remediated by performing the operations to update a package to a newer version that does not have the vulnerability. The cloud-to-code tracer in these cases can retrieve from a database of remediation actions a remediation action which corresponds to the type of the security issue in the cloud-based workload. If there is not a predefined remediation action corresponding to the type of the security issue, the cloud-to-code tracer submits the security issue metadata and determined ownership information of the file that is the source of the security issue to a downstream service for determination of remediation actions. Based on receiving a response from the downstream service, operational flow continues at block 608.

At block 608, the cloud-to-code tracer updates a dashboard (e.g., a cloud environment dashboard) with the cloud-to-code trace graph and determined remediation action. The cloud-to-code graph updates a dashboard belonging to the determined custodian so they can view the full context of the security issue in the cloud-based workload. From the dashboard, the workload's custodian can trigger the determined remediation action. Triggering the remediation action involves updating the file that is the source of the security issue (e.g., updating a vulnerable package or fixing a misconfiguration), followed by the cloud-based workload being re-built and re-deployed. Since an update to a source file can impact multiple workloads, remediating the security issue at its source also addresses the security issue across workloads.

### Variations

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, which employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

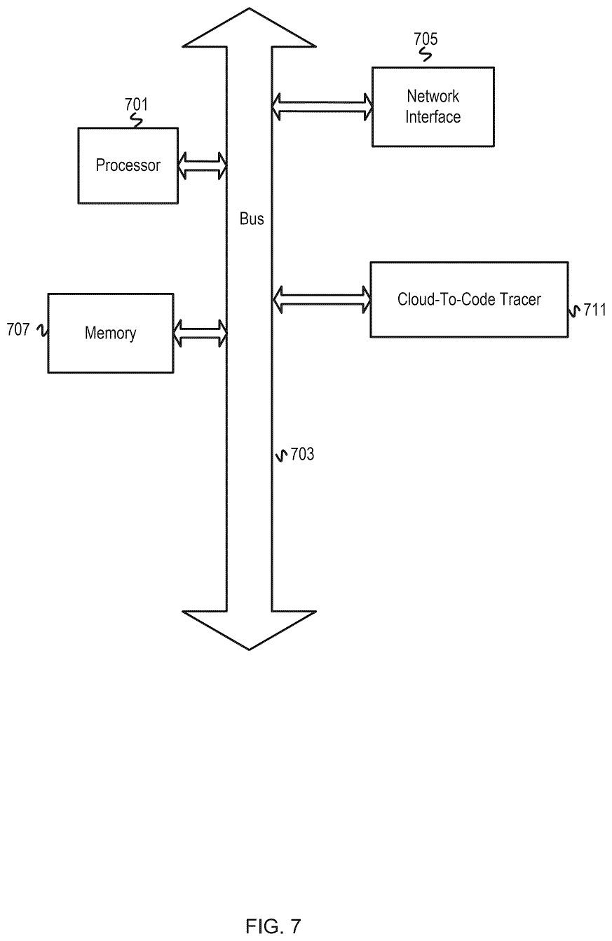

FIG. 7 depicts an example computer system with a cloud-to-code tracer. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes the cloud-to-code tracer 711. The cloud-to-code tracer 711 responds to detections of security issues with workloads by any one of various cloud runtime scanners that detect various security issues, such as secret exposure, misconfiguration, and already identified vulnerabilities (e.g., CVEs). The cloud-to-code tracer 711 traces the security issue from the workload to its source. Tracing will vary depending upon type of workload and analysis to identify a source will vary depending upon the security issue. The cloud-to-code tracer 711 initially identifies repositories of images or stores of files based on an identifier related to the workload. As the cloud-to-code tracer 711 traces through stages that precede the runtime workload (e.g., deploy and/or build stage) the cloud-to-code tracer 711 retrieves metadata of a cloud resource (e.g., image metadata and build job metadata) to identify a resource of a next preceding stage. Ultimately, the cloud-to-code tracer 711 arrives at a code repository and examines contents of a code repository depending upon the security issue (e.g., searching for a function that exposes credentials or examining application security scan data to identify a source package with a CVE). The cloud-to-code tracer 711 generates a visualization of the cloud-to-code trace to assist a security analyst or administrator in remediation of the security issue. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
tracing, across delivery stages of a cloud-based workload, a first security issue detected for the cloud-based workload from the cloud-based workload to code, wherein the tracing comprises,
retrieving metadata of an image or file underlying the cloud-based workload from deployment stage data based on an identifier corresponding to the cloud-based workload;
based on the metadata of the first resource, examining build stage data to determine an identifier of a build stage resource; and
determining a first instance of code based, at least in part, on metadata of the build stage resource; and
determining a remediation for the code that corresponds to the first security issue.

2. The method of claim 1, wherein the image comprises one of a container image and a virtual machine image and the file underlying the cloud-based workload comprises a serverless function file.

3. The method of claim 1, wherein retrieving metadata of an image comprises searching an image registry or artifact registry if the cloud-based workload type is container or virtual machine and searching an object store if the cloud-based workload is a serverless function.

4. The method of claim 1, wherein examining build stage data comprises searching repositories of a continuous integration/continuous deployment pipeline for a build job identifier indicated in metadata of the image underlying the cloud-based workload.

5. The method of claim 1 further comprising determining which delivery stages to trace across based on at least one of a type of the cloud-based workload and a type of the first security issue.

6. The method of claim 5 further comprising identifying repositories and types of artifacts of the determined stages to trace across, wherein examining the build stage data comprises identifying artifacts in the identified repositories based on the determined types of artifacts and examining the artifacts and metadata of the artifacts.

7. The method of claim 6, wherein identifying repositories and types of artifacts of the determined stages to trace across comprises accessing a graph that indicates artifacts and relationships among the artifacts.

8. The method of claim 1, further comprising identifying a custodian of the cloud-based workload and communicating the remediation to the identified custodian, wherein identifying the custodian comprises determining a namespace associated with the cloud-based workload and identifying the custodian based at least on the namespace.

9. The method of claim 1, wherein the first security issue corresponds to at least one of a vulnerability, exposure of a secret, malware, a misconfiguration, and a compliance issue, and wherein the cloud-based workload corresponds to a container, a virtual machine, or a serverless function.

10. A non-transitory machine-readable medium having program code stored thereon, the program code comprising instructions to:
trace from cloud-to-code a security issue detected for a cloud-based workload across stages of a cloud delivery pipeline, wherein the instructions to trace the security issue detected for the cloud-based workload comprise instructions to,
determine, from metadata of the cloud-based workload, an identifier of a production stage resource of the cloud-based workload; and
for each production stage resource identifier,
examine deployment stage data based on the production stage resource identifier to determine a first identifier of a deployment stage resource corresponding to the production stage resource;
based on the first identifier and metadata of the production stage resource, examine build stage data to determine a second identifier of a build stage resource corresponding to the deployment stage resource; and
determine a first instance of code based, at least in part, on the second identifier; and
determine a remediation for the code that corresponds to the detected security issue.

11. The non-transitory machine-readable medium of claim 9, wherein the program code further comprises instructions to:
constrain examination of the deployment stage data based on a type of the cloud-based workload.

12. The non-transitory machine-readable medium of claim 10, wherein the instructions to constrain examination of the deployment stage data based on a type of the cloud-based workload comprise instructions to constrain examination to an image registry if the cloud-based workload type is container, constrain examination to one or more of an image registry and repositories if the cloud-based workload type is a virtual machine, or constrain examination to repositories of a continuous integration/continuous deployment (CI/CD) pipeline if the cloud-based workload type is either application or serverless.

13. The non-transitory machine-readable medium of claim 9, wherein the program code further comprises instructions to:
determine which stages of the cloud delivery pipeline to trace across based on at least one of a type of the cloud-based workload and a type of the security issue.

14. The non-transitory machine-readable medium of claim 12, wherein the program code further comprises instructions to:
identify repositories and types of artifacts of the determined stages to trace across, wherein the instructions to examine the deployment stage data and the build stage data comprise instructions to identify artifacts in the identified repositories based on the determined types of artifacts and examine the artifacts and metadata of the artifacts.

15. The non-transitory machine-readable medium of claim 13, wherein the instructions to identify repositories and types of artifacts of the determined stages to trace across comprise instructions to access a graph that indicates stages of the cloud delivery pipeline, relationships among the stages, and at least one of repositories and artifacts of each stage and relationships thereof.

16. The non-transitory machine-readable medium of claim 9, wherein the program code further comprises instructions to identify a custodian of the cloud-based workload and communicate the remediation to the identified custodian, wherein the instructions to identify the custodian comprise instructions to determine a namespace associated with the cloud-based workload and identify the custodian based at least on the namespace.

17. An apparatus comprising:
a processor; and
a machine-readable medium having instructions stored thereon that are executable by the processor to cause the apparatus to,
trace, across stages of a cloud delivery pipeline, a security issue detected for a cloud-based workload from the cloud-based workload to code, wherein the instructions to trace the security issue detected for a cloud-based workload from the cloud-based workload to code comprise instructions executable by the processor to cause the apparatus to,
determine, from metadata of the cloud-based workload, one or more identifiers of one or more runtime resources of the cloud-based workload; and
for each runtime resource identifier,
examine deployment stage data based on the runtime resource identifier to determine a first identifier of a first resource corresponding to the runtime resource;
based on the first identifier and metadata of the first resource, examine build stage data to determine a second identifier of a second resource corresponding to the first resource; and
determine a first instance of code based, at least in part, on the second identifier; and
determine a remediation for the code that corresponds to the security issue.

18. The apparatus of claim 16, wherein the machine-readable medium further has stored thereon instructions executable by the processor to cause the apparatus to:
constrain examination to an image registry if the cloud-based workload type is container, constrain examination to one or more of an image registry and repositories if the cloud-based workload type is a virtual machine, or constrain examination to repositories of a continuous integration/continuous deployment pipeline if the cloud-based workload type is either application or serverless.

19. The apparatus of claim 16, wherein the machine-readable medium further has stored thereon instructions executable by the processor to cause the apparatus to:
determine which stages of the cloud delivery pipeline to trace across based on at least one of a type of the cloud-based workload and a type of the security issue.

20. The apparatus of claim 19, wherein the machine-readable medium further has stored thereon instructions executable by the processor to cause the apparatus to:
identify repositories and types of artifacts of the determined stages to trace across, wherein the instructions to examine the deployment stage data and the build stage data comprise instructions executable by the processor to cause the apparatus to identify artifacts in the identified repositories based on the determined types of artifacts and examine the artifacts and metadata of the artifacts.
